(19) United States
(12) Patent Application Publication
(10) Pub. No.: US 2008/0243718 A1
(43) Pub. Date: Oct. 2, 2008

(54) Financial structure and investment vehicle enabling foreign persons to invest in U.S. based oil, gas and natural gas resource producing properties and potential producing properties in an optimal tax structure

(76) Inventor: Mandana Dominique Farhang, Belvedere, CA (US)

Correspondence Address: MANDANA DOMINIQUE FARHANG, P.O.BOX 274, BELVEDERE, CA, 94920, US

(21) Appl. No.: 12/077,457

(22) Filed: Mar. 17, 2008

Related U.S. Application Data
(60) Provisional application No. 60/918,318, filed on Mar. 16, 2007.

(51) Int. Cl. G06Q 40/00

(52) U.S. Cl. 705/36 R

(57) ABSTRACT

The various embodiments of the present invention provide a method for providing a financial structure and investment vehicle that enables foreign persons, Canadian Income Trusts and United States (U.S.) based investors to invest in U.S. based real property interests including oil, gas and other natural resource producing properties or potential producing properties in an optimal tax structure. The income stream received from the investments is recategorized as a production payment and taxed at the specific treaty withholding tax rate on interest on real property mortgages between the U.S. and resident country of Foreign Person or Canadian Income Trust.

### BACKGROUND

1. Technical Field

The embodiments herein generally relate to the fields of investment vehicles and financial structures and more specifically relates to financial structures that result in an optimal tax structure; cross border investments in oil, gas and other natural resources; investments in oil, gas, minerals and other natural resources; royalties and production payments resulting from investments in oil, gas and other natural resources; exploration and development of oil, gas and other natural resources; investment vehicles and financial structures that pertain to oil, gas and natural resource investments in producing properties and potential producing properties; investments in U.S. based oil, gas and natural resource producing properties and potential producing properties by foreign persons from various countries.

2. Description of the Related Art

Foreign person(s) investing in U.S. based oil, gas and natural resource producing Properties are typically subject to a U.S. withholding tax on income derived from natural resource royalties. This withholding tax in and of itself, or in addition to any other relevant corporate or personal tax in the foreign person's country of residence causes such an investment to be viewed as unattractive relative to other investments with a comparable risk adjusted return. As a result, the flow of capital from foreign person(s) into such U.S. based investments and initiatives that include, but are not limited to, the initiative to explore and develop U.S based oil and natural gas reserves in order to reduce the U.S.'s reliance on non-North American oil and natural gas, is negatively impacted. Prior to the inventor's invention of the financial structure and investment vehicle there was no known solution to the problem that did not trigger other tax consequences. The only attempted solution known to the inventor was one that was suggested for only one type of Foreign Person (i.e. a Canadian tax-exempt Oil and Gas Income Trust) that was considering making an investment into a U.S. Corporation that operated oil and gas wells. The attempted solution does not provide proper solution of the problem because the Department of Finance Canada categorized the U.S. Corporation as the Canadian Income Trust's “controlled foreign affiliate” and this triggered an additional Canadian tax called the “Foreign Accrual Property Income (FAPI)” tax.

Hence there is a need to create a financial structure or investment vehicle that enables foreign persons to invest in U.S. based oil, gas and natural resource producing properties in an optimal tax structure.

Foreign person(s) making an investment into an oil, gas and natural resource potential producing property upon which there will be exploration or development is considered to be involved in the business or trade that they are investing in as it pertains to U.S. tax rules, even if the foreign person(s) does not personally conduct the operations, exploration or development activities of the oil, gas or other natural resources. This typically results in the foreign person(s) being taxed at a U.S. withholding tax rate that is higher than the U.S. withholding rate on “Interest on real property mortgages”. This U.S. withholding tax in and of itself, or in addition to any other relevant corporate or personal tax liabilities in the foreign person's country of residence causes such an investment to be viewed as unattractive relative to other investments with a comparable risk adjusted return. This problem applies to US-based investors as well. Prior to the inventor's invention of the financial structure and investment vehicle there was no known solution to the problem. The only attempted solution known to the inventor was one that was suggested for only one type of Foreign Person (i.e. a Canadian tax-exempt Oil and Gas Income Trust) that was considering making an investment into a U.S. Corporation that operated oil and gas wells (Producing Properties). The attempted solution did not solve the problem because the Department of Finance Canada categorized the U.S. Corporation as the Canadian Income Trust's “controlled foreign affiliate” and this triggered an additional Canadian tax liability called the “Foreign Accrual Property Income (FAPI)” tax.

Hence there is a need to create a financial structure or investment vehicle that enables Foreign Person(s) to invest in U.S.-based oil, gas and natural resource Potential Producing Properties in an optimal tax structure.

Canadian Income Trusts are tax exempt trusts in Canada that are typically set up to acquire and hold oil, gas and natural resource producing properties and/or potential producing properties on behalf of beneficiaries known as unit holders. In a simplified form, these trusts are similar to Real Estate Investment Trusts (REITS) in the U.S. except that they hold oil, gas and natural resource producing properties instead of real estate income producing properties. It has become important for these trusts to acquire U.S. based oil, gas and natural resource interests in order to provide their underlying unit holders with further diversification for the purpose of reducing risk. In addition, Canadian Income Trusts are for the most part unable to explore or develop potential producing properties due to their investment guidelines. Therefore they must continually add new producing properties to their existing portfolio of depleting producing properties. This provides U.S. based individuals, corporations and other entities who are willing to take on the initial risks associated with exploration and development of these properties, with an excellent potential acquirer of the resources (once they have been explored and developed and are considered Producing Properties). However the U.S. withholding tax on Natural Resource Royalties levied at the trust level and again at the level of the underlying unit holder, the categorization of the trust as the “owner” or “controlling entity” of the investment vehicle that triggers Canada's Foreign Accrual Property Income (FAPI) and Canada's Foreign Investment Entity (FIE) rules that require the “mark-to-market” of income inclusions from Canadian Income Trusts and Canadian Foreign Persons make this investment into U.S. based oil, gas and natural resource producing properties unattractive for Canadian Income Trusts and Canadian Foreign Persons. Prior to the inventor's invention of the financial structure and investment vehicle there was no known solution to the problem that did not trigger other tax consequences. The only attempted solution known to the inventor was one that was suggested for a Canadian Income Trust that was considering making an investment into a U.S. Corporation that operated oil and gas wells. The attempted solution did not solve the problem because the Department of Finance Canada categorized the U.S. Corporation as the Canadian Income Trust's “controlled foreign affiliate” and this triggered an additional Canadian tax liability called the “Foreign Accrual Property Income (FAPI)” tax.

Hence there is a need to create a financial structure or investment vehicle that enables Canadian Foreign Persons and Canadian Income Trusts (also known as Canadian Royalty Trusts) to invest in U.S.-based oil, gas and natural resource producing properties in an optimal tax structure.

### SUMMARY

The embodiments of the invention enables Foreign Persons, Canadian Income Trusts and U.S.-based investors to invest in U.S.-based real property interests including oil, gas and other natural resource Producing Properties or Potential Producing Properties in an optimal tax structure. The embodiments of the invention further enables the income stream received from the investments to be recategorized as a Production Payment and taxed at the specific treaty withholding tax rate on interest on real property mortgages between the U.S. and resident country of Foreign Person or Canadian Income Trust. Similarly it enables Foreign Persons and U.S.-based investors to invest in Canadian oil, gas and natural resource Producing Properties or Potential Producing Properties such that the income stream received from these investments is taxed at the specific treaty withholding rate on interest between Canada and the resident country of the Foreign Persons. In addition, the embodiments of the invention provide a U.S.-based financial structure and investment vehicle that is similar to a Real Estate Investment Trust (REIT). The difference is that it owns title to oil, gas or other natural resource Producing Properties or Potential Producing Properties. The investment trust may be called an Oil Investment Trust (OIT), Gas Investment Trust (GIT), Oil and Gas Investment Trust (OGIT) or Natural Resource Investment Trust (NRIT), and within this investment trust U.S.-based and Foreign Persons including Canadian Income Trusts can co-invest and earn income from such Producing Properties or Potential Producing Properties in an optimal tax structure.

Foreign Person(s) investing in U.S. based oil, gas and natural resource Producing Properties are typically subject to a U.S. withholding tax on income derived from natural resource royalties. This withholding tax in and of itself, or in addition to any other relevant corporate or personal tax in the Foreign Person's country of residence causes such an investment to be viewed as unattractive relative to other investments with a comparable risk adjusted return. As a result, the flow of capital from Foreign Person(s) into such U.S. based investments and initiatives that include, but are not limited to, the initiative to explore and develop U.S based oil and natural gas reserves in order to reduce the U.S.'s reliance on non-North American oil and natural gas is negatively impacted.

In order to solve this problem, the embodiments of the invention provide a method for providing financial structure and investment vehicle that utilizes Section 636 of the U.S. Tax Code and enables the income received from a Foreign Person's investment in U.S. based oil, gas and other natural resource Producing Properties to be treated as Production Payments, thus enabling the payments to be considered as payments of interest and principal on a mortgage loan. As a result, the Foreign Person(s) making the investment is subject to the U.S. withholding tax that specifically pertains to its resident country's negotiated treaty rate with the U.S. on “Interest on real property mortgages”. This is accomplished by structuring the investment comprising the steps of: foreign person(s) makes an investment in the form of a loan to a U.S. entity (U.S. Entity 1) that is not owned by Foreign Person(s) and that takes on, but is not limited to, one of the forms mentioned (i.e. Limited Liability Company (LLC), Limited Liability Partnership (LLP) or Limited Partnership (LP)); in consideration of the loan, U.S. Entity 1 pays Foreign Person(s) interest that does not to exceed the lawful rate set by the State jurisdiction of the U.S. entity and a principal payment, the timing of which is determined by the pre-negotiated terms of the investment; U.S. Entity 1 uses the loan to acquire the rights to the production derived from the Producing Property (or Producing Properties) from a separate U.S. entity (U.S. Entity 2) that is not owned by Foreign Person(s), that takes on, but is not limited to, one of the forms mentioned (i.e. Limited Liability Company (LLC), Limited Liability Partnership (LLP) or Limited Partnership (LP)) and that owns title to the Producing Properties; U.S. Entity 2 then provides U.S. Entity 1 with a payment (resulting from the production of the underlying assets owned by Entity 2) that is recategorized as a Production Payment that is taxed as interest on a mortgage loan. The payment can be adjusted according to a pre-determined formula to reflect either an appreciation or depreciation in the value of the underlying asset(s) (Producing Properties), or for management fees as negotiated between the parties; U.S. Entity 1 then provides Foreign Person(s) with a payment that is also recategorized as a Production Payment that is taxed as interest on a mortgage loan.

The financial structure or investment vehicle also has the option of hedging out of a Foreign Person's exposure to the U.S. dollar, either fully or partially, using derivatives. This can be executed separately on behalf of each Foreign Person depending on its specific need, or it can be executed jointly on behalf of one or more Foreign Persons depending upon their specific investment objectives. The financial structure or investment vehicle also has the option of hedging out of a Foreign Person's exposure to fluctuations in the price of the underlying natural resource commodity, either fully or partially, using derivatives. This can be executed separately on behalf of each Foreign Person depending on its specific need, or it can be executed jointly on behalf of one or more Foreign Persons depending upon their specific investment objectives.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Other objects, features and advantages will occur to those skilled in the art from the following description of the preferred embodiments and the accompanying drawings in which:

FIG. 1 shows a flow diagram illustrating a financial structure/investment vehicle that enables the income received from a Foreign Person's investment in U.S.-based oil, gas and other natural resource Producing Properties is treated as Production Payments, thus enabling the payments to be considered as payments of interest and principal on a mortgage loan according to an embodiment of the invention.

FIG. 2 shows a flow diagram illustrating a financial structure/investment vehicle that enables the income received from a Foreign Person's investment in U.S.-based oil, gas and other natural resource Potential Producing Properties to be recategorized as Production Payments, thus enabling them to be categorized as payments of interest and principal on a mortgage loan according to an embodiment of the invention.

FIG. 3 shows a flow diagram illustrating a financial structure/investment vehicle that enables the income received from a Canadian Foreign Persons and Canadian Income Trusts' (also known as Canadian Royalty Trusts') investment in U.S.-based oil, gas and other natural resource Potential Producing Properties to be recategorized as Production Payments, thus enabling them to be categorized as payments of interest and principal on a mortgage loan according to an embodiment of the invention.

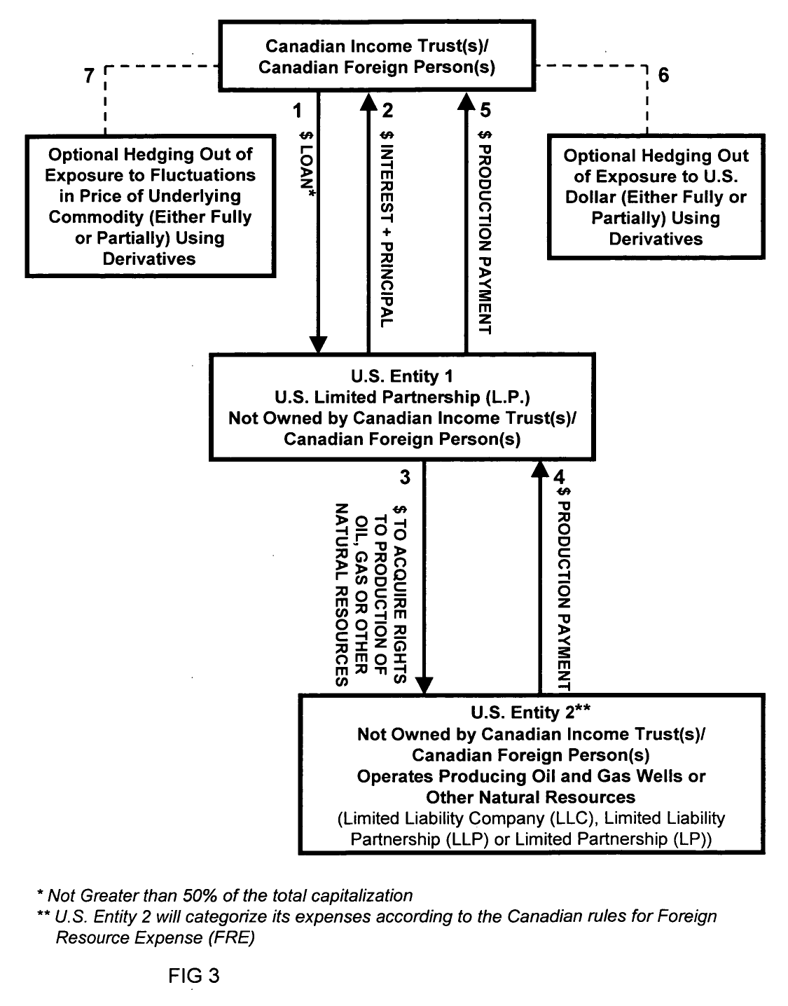

FIG. 4 shows a flow diagram illustrating a financial structure/investment vehicle that enables the income received from a Canadian Foreign Persons and Canadian Income Trusts' (also known as Canadian Royalty Trusts') investment in U.S.-based oil, gas and other natural resource Potential Producing Properties to be recategorized as Production Payments, thus enabling them to be categorized as payments of interest and principal on a mortgage loan according to an embodiment of the invention.

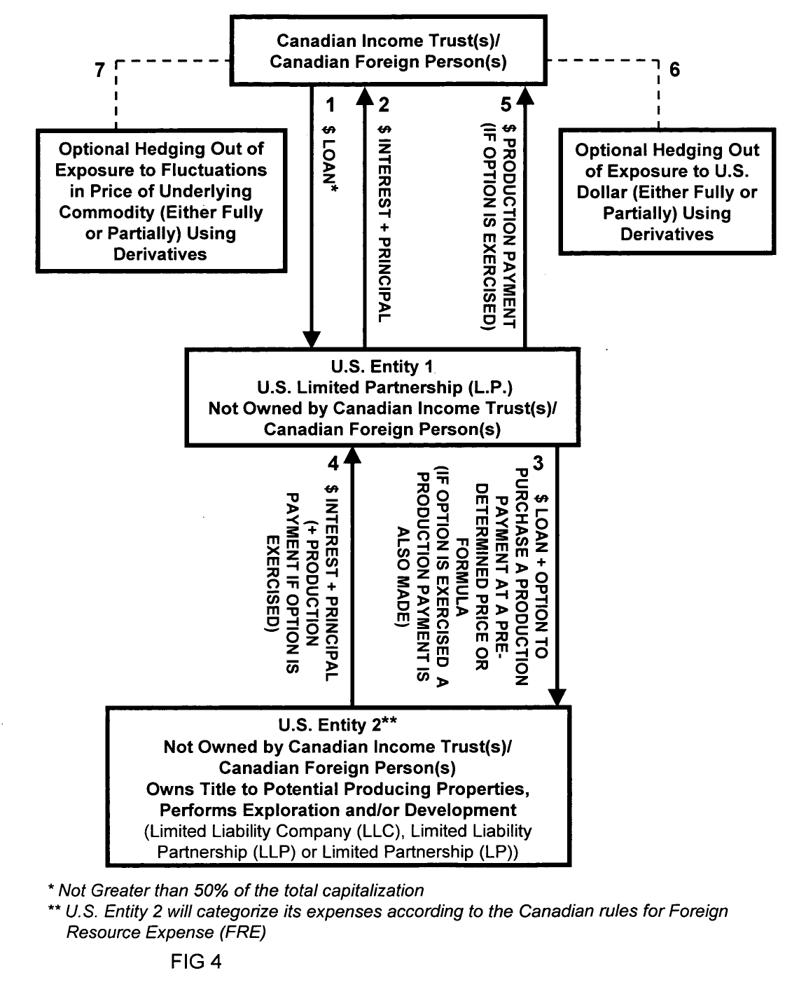

Although specific features of the present invention are shown in some drawings and not in others. This is done for convenience only as each feature may be combined with any or all of the other features in accordance with the present invention.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments of the invention enables Foreign Persons, Canadian Income Trusts and U.S. based investors to invest in U.S. based real property interests including oil, gas and other natural resource Producing Properties or Potential Producing Properties in an optimal tax structure. The embodiments of the invention further enables the income stream received from the investments to be recategorized as a Production Payment and taxed at the specific treaty withholding tax rate on interest on real property mortgages between the U.S. and resident country of Foreign Person or Canadian Income Trust. Similarly it enables Foreign Persons and U.S.-based investors to invest in Canadian oil, gas and natural resource Producing Properties or Potential Producing Properties such that the income stream received from these investments is taxed at the specific treaty withholding rate on interest between Canada and the resident country of the Foreign Persons. In addition, the embodiments of the invention provide a U.S.-based financial structure and investment vehicle that is similar to a Real Estate Investment Trust (REIT). The difference is that it owns title to oil, gas or other natural resource Producing Properties or Potential Producing Properties. The investment trust may be called an Oil Investment Trust (OIT), Gas Investment Trust (GIT), Oil and Gas Investment Trust (OGIT) or Natural Resource Investment Trust (NRIT), and within this investment trust U.S.-based and Foreign Persons including Canadian Income Trusts can co-invest and earn income from such Producing Properties or Potential Producing Properties in an optimal tax structure.

Foreign Person(s) investing in U.S. based oil, gas and natural resource Producing Properties are typically subject to a U.S. withholding tax on income derived from natural resource royalties. This withholding tax in and of itself, or in addition to any other relevant corporate or personal tax in the Foreign Person's country of residence causes such an investment to be viewed as unattractive relative to other investments with a comparable risk adjusted return. As a result, the flow of capital from Foreign Person(s) into such U.S. based investments and initiatives that include, but are not limited to, the initiative to explore and develop U.S based oil and natural gas reserves in order to reduce the U.S.'s reliance on non-North American oil and natural gas, is negatively impacted.

In order to solve this problem, the embodiments of the invention provide a method for providing financial structure and investment vehicle that utilizes Section 636 of the U.S. Tax Code and enables the income received from a Foreign Person's investment in U.S. based oil, gas and other natural resource Producing Properties to be treated as Production Payments, thus enabling the payments to be considered as payments of interest and principal on a mortgage loan. As a result, the Foreign Person(s) making the investment is subject to the U.S. withholding tax that specifically pertains to its resident country's negotiated treaty rate with the U.S. on “Interest on real property mortgages”. This is accomplished by structuring the investment comprising the steps of: foreign person(s) makes an investment in the form of a loan to a U.S. entity (U.S. Entity 1) that is not owned by Foreign Person(s) and that takes on, but is not limited to, one of the forms mentioned (i.e. Limited Liability Company (LLC), Limited Liability Partnership (LLP) or Limited Partnership (LP)); in consideration of the loan, U.S. Entity 1 pays Foreign Person(s) interest that does not to exceed the lawful rate set by the State jurisdiction of the U.S. entity and a principal payment, the timing of which is determined by the pre-negotiated terms of the investment; U.S. Entity 1 uses the loan to acquire the rights to the production derived from the Producing Property (or Producing Properties) from a separate U.S. entity (U.S. Entity 2) that is not owned by Foreign Person(s), that takes on, but is not limited to, one of the forms mentioned (i.e. Limited Liability Company (LLC), Limited Liability Partnership (LLP) or Limited Partnership (LP)) and that owns title to the Producing Properties; U.S. Entity 2 then provides U.S. Entity 1 with a payment (resulting from the production of the underlying assets owned by Entity 2) that is recategorized as a Production Payment that is taxed as interest on a mortgage loan. The payment can be adjusted according to a pre-determined formula to reflect either an appreciation or depreciation in the value of the underlying asset(s) (Producing Properties), or for management fees as negotiated between the parties; U.S. Entity 1 then provides Foreign Person(s) with a payment that is also recategorized as a Production Payment that is taxed as interest on a mortgage loan.

The financial structure or investment vehicle also has the option of hedging out of a Foreign Person's exposure to the U.S. dollar, either fully or partially, using derivatives. This can be executed separately on behalf of each Foreign Person depending on its specific need, or it can be executed jointly on behalf of one or more Foreign Persons depending upon their specific investment objectives. The financial structure or investment vehicle also has the option of hedging out of a Foreign Person's exposure to fluctuations in the price of the underlying natural resource commodity, either fully or partially, using derivatives. This can be executed separately on behalf of each Foreign Person depending on its specific need, or it can be executed jointly on behalf of one or more Foreign Persons depending upon their specific investment objectives.

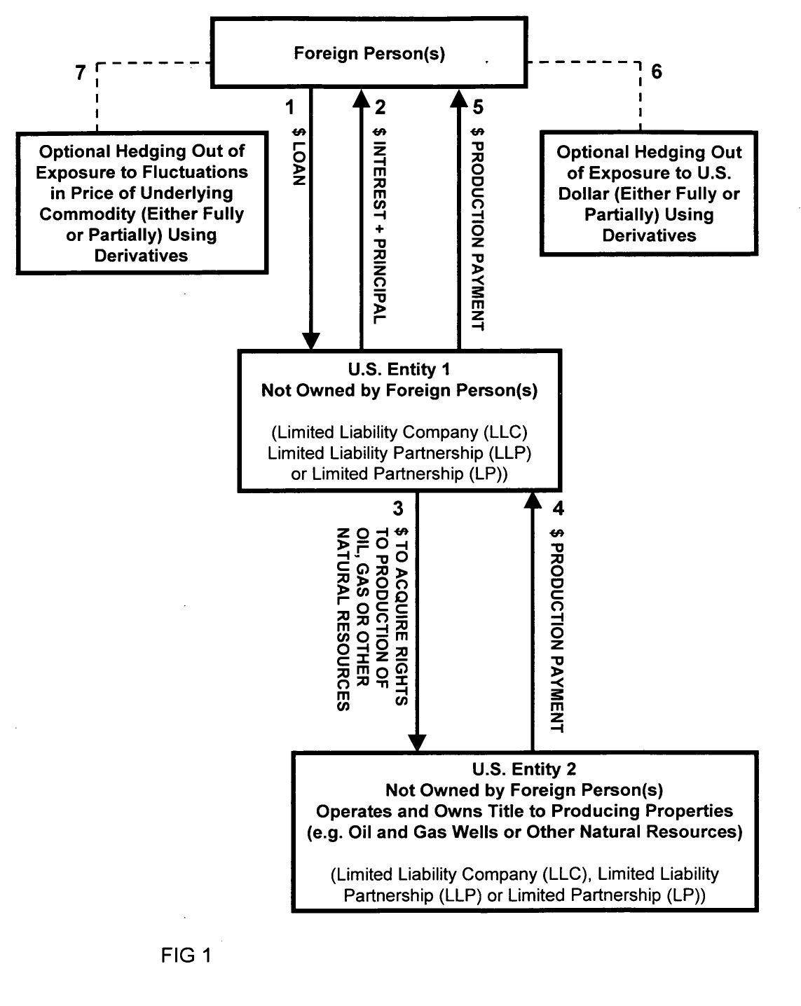

According to one embodiment of the present invention a foreign Person from Australia receiving income from an investment in U.S.-based oil, gas and other natural resource producing properties that utilizes the inventor's financial structure and investment vehicle (as illustrated in FIG. 1) will be subject to the Australia/U.S. withholding tax on the “Interest on real property mortgages”.

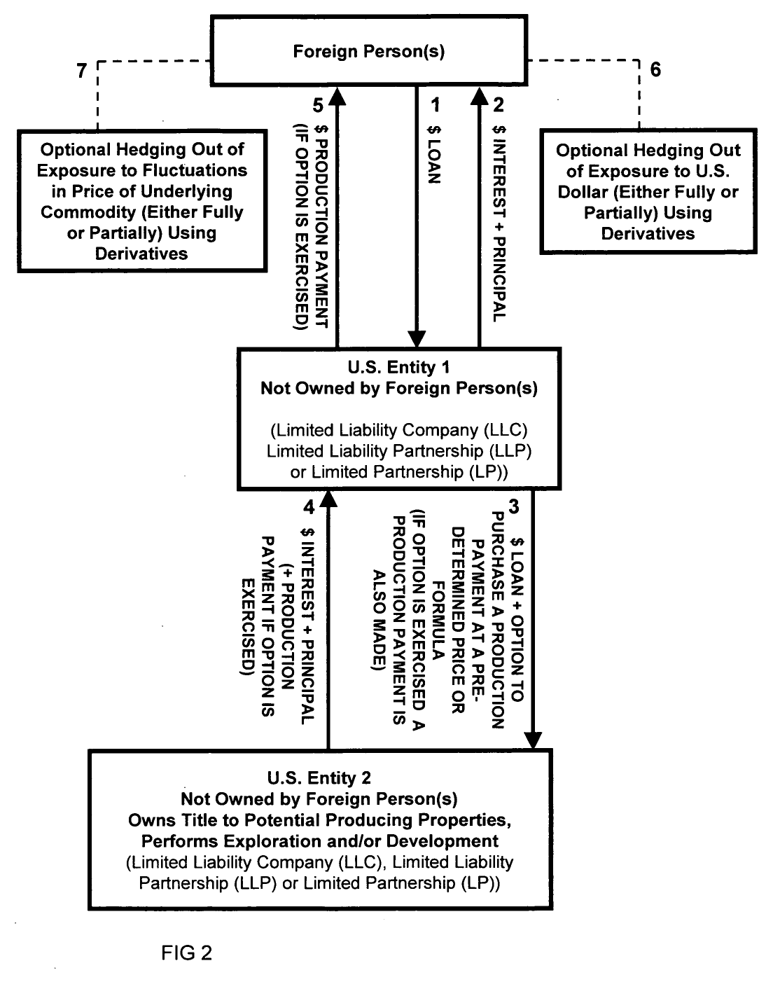

According to one embodiment of the present invention a foreign person from Australia receiving income from an investment in U.S.-based oil, gas and other natural resource Potential Producing Properties that utilizes the inventor's financial structure and investment vehicle (as illustrated in FIG. 2) will be subject to the Australia/U.S. withholding tax on the “Interest on real property mortgages”.

According to one embodiment of the present invention a foreign person from Austria receiving income from an investment in U.S.-based oil, gas and other natural resource Producing Properties that utilizes the inventor's financial structure and investment vehicle (as illustrated in FIG. 1) will be subject to the Austria/U.S. withholding tax on the “Interest on real property mortgages”.

According to one embodiment of the present invention a foreign person from Austria receiving income from an investment in U.S.-based oil, gas and other natural resource Potential Producing Properties that utilizes the inventor's financial structure and investment vehicle (as illustrated in FIG. 2) will be subject to the Austria/U.S. withholding tax on the “Interest on real property mortgages”.

According to one embodiment of the present invention a foreign person from Barbados receiving income from an investment in U.S.-based oil, gas and other natural resource Producing Properties that utilizes the inventor's financial structure and investment vehicle (as illustrated in FIG. 1) will be subject to the Barbados/U.S. withholding tax on the “Interest on real property mortgages”.

According to one embodiment of the present invention a foreign person from Barbados receiving income from an investment in U.S.-based oil, gas and other natural resource Potential Producing Properties that utilizes the inventor's financial structure and investment vehicle (as illustrated in FIG. 2) will be subject to the Barbados/U.S. withholding tax on the “Interest on real property mortgages”.

According to one embodiment of the present invention a foreign person from Belgium receiving income from an investment in U.S.-based oil, gas and other natural resource Producing Properties that utilizes the inventor's financial structure and investment vehicle (as illustrated in FIG. 1) will be subject to the Belgium/U.S. withholding tax on the “Interest on real property mortgages”.

According to one embodiment of the present invention a foreign person from Belgium receiving income from an investment in U.S.-based oil, gas and other natural resource Potential Producing Properties that utilizes 14 of 33 the inventor's financial structure and investment vehicle (as illustrated in FIG. 2) will be subject to the Belgium/U.S. withholding tax on the “Interest on real property mortgages”.

According to one embodiment of the present invention a Canadian foreign person or Canadian Income Trust receiving income from an investment in U.S.-based oil, gas and other natural resource Producing Properties that utilizes the inventor's financial structure and investment vehicle (as illustrated in FIG. 1) will be subject to the Canada/U.S. withholding tax on the “Interest on real property mortgages”. The Canadian investor invests in a U.S. Limited Partnership, so it is not subject to the Canadian “Foreign Accrual Property Income (FAPI)” tax. The Canadian entity's investment is not greater than 50% of the total capitalization and it does not have any special voting rights so it is not subject to any Foreign Accrual Property Income (FAPI) concerns in Canada. U.S. Entity 2 categorizes its expenses according to the Canadian rules for Foreign Resource Expense and this eliminates not only trust level tax, but also beneficiary level tax (for the unit holders of the Income Trust).

According to one embodiment of the present invention a Canadian Foreign Person or Canadian Income Trust receiving income from an investment in U.S.-based oil, gas and other natural resource Potential Producing Properties that utilizes the inventor's financial structure and investment vehicle (as illustrated in FIG. 2) will be subject to the Canada/U.S. withholding tax on the “Interest on real property mortgages”. The Canadian investor invests in a U.S. Limited Partnership, so it is not subject to the Canadian “Foreign Accrual Property Income (FAPI)” tax. The Canadian entity's investment is not greater than 50% of the total capitalization and it does not have any special voting rights so it is not subject to any Foreign Accrual Property Income (FAPI) concerns in Canada. U.S. Entity 2 categorizes its expenses according to the Canadian rules for Foreign Resource Expense and this eliminates not only trust level tax, but also beneficiary level tax (for the unit holders of the Income Trust).

According to one embodiment of the present invention a foreign person from China (People's Republic of) receiving income from an investment in U.S.-based oil, gas and other natural resource Producing Properties that utilizes the inventor's financial structure and investment vehicle (as illustrated in FIG. 1) will be subject to the China (People's Republic of)/U.S. withholding tax on the “Interest on real property mortgages”.

According to one embodiment of the present invention a foreign person from China (People's Republic of) receiving income from an investment in U.S.-based oil, gas and other natural resource Potential Producing Properties that utilizes the inventor's financial structure and investment vehicle (as illustrated in FIG. 2) will be subject to the China (People's Republic of)/U.S. withholding tax on the “Interest on real property mortgages”.

According to one embodiment of the present invention a foreign person from China (Commonwealth of Independent States) receiving income from an investment in U.S.-based oil, gas and other natural resource Producing Properties that utilizes the inventor's financial structure and investment vehicle (as illustrated in FIG. 1) will be subject to the Commonwealth of Independent 15 of 33 States)/U.S. withholding tax on the “Interest on real property mortgages”.

According to one embodiment of the present invention a foreign person from China (Commonwealth of Independent States) receiving income from an investment in U.S.-based oil, gas and other natural resource Potential Producing Properties that utilizes the inventor's financial structure and investment vehicle (as illustrated in FIG. 2) will be subject to the China (Commonwealth of Independent States)/U.S. withholding tax on the “Interest on real property mortgages”.

According to one embodiment of the present invention a foreign person from Cyprus receiving income from an investment in U.S.-based oil, gas and other natural resource Potential Producing Properties that utilizes the inventor's financial structure and investment vehicle (as illustrated in FIG. 2) will be subject to the Cyprus/U.S. withholding tax on the “Interest on real property mortgages”.

According to one embodiment of the present invention a foreign person from Cyprus receiving income from an investment in U.S.-based oil, gas and other natural resource Producing Properties that utilizes the inventor's financial structure and investment vehicle (as illustrated in FIG. 1) will be subject to the Cyprus/U.S. withholding tax on the “Interest on real property mortgages”.

According to one embodiment of the present invention a foreign person from Czech Republic receiving income from an investment in U.S.-based oil, gas and other natural resource Potential Producing Properties that utilizes the inventor's financial structure and investment vehicle (as illustrated in FIG. 2) will be subject to the Czech Republic/U.S. withholding tax on the “Interest on real property mortgages”.

According to one embodiment of the present invention a foreign person from Czech Republic receiving income from an investment in U.S.-based oil, gas and other natural resource Producing Properties that utilizes the inventor's financial structure and investment vehicle (as illustrated in FIG. 1) will be subject to the Czech Republic/U.S. withholding tax on the “Interest on real property mortgages”.

According to one embodiment of the present invention a foreign person from Denmark receiving income from an investment in U.S.-based oil, gas and other natural resource Potential Producing Properties that utilizes the inventor's financial structure and investment vehicle (as illustrated in FIG. 2) will be subject to the Denmark/U.S. withholding tax on the “Interest on real property mortgages”.

According to one embodiment of the present invention a foreign person from Denmark receiving income from an investment in U.S.-based oil, gas and other natural resource Producing Properties that utilizes the inventor's financial structure and investment vehicle (as illustrated in FIG. 1) will be subject to the Denmark/U.S. withholding tax on the “Interest on real property mortgages”.

According to one embodiment of the present invention a foreign person from Egypt receiving income from an investment in U.S.-based oil, gas and other natural resource Potential Producing Properties that utilizes the inventor's financial structure and investment vehicle (as illustrated in FIG. 2) will be subject to the Egypt/U.S. withholding tax on the “Interest on real property mortgages”.

According to one embodiment of the present invention a foreign person from Egypt receiving income from an investment in U.S.-based oil, gas and other natural resource Producing Properties that utilizes the inventor's financial structure and investment vehicle (as illustrated in FIG. 1) will be subject to the Egypt/U.S. withholding tax on the “Interest on real property mortgages”.

According to one embodiment of the present invention a foreign person from Estonia receiving income from an investment in U.S.-based oil, gas and other natural resource Potential Producing Properties that utilizes the inventor's financial structure and investment vehicle (as illustrated in FIG. 2) will be subject to the Estonia/U.S. withholding tax on the “Interest on real property mortgages”.

According to one embodiment of the present invention a foreign person from Estonia receiving income from an investment in U.S.-based oil, gas and other natural resource Producing Properties that utilizes the inventor's financial structure and investment vehicle (as illustrated in FIG. 1) will be subject to the Estonia/U.S. withholding tax on the “Interest on real property mortgages”.

According to one embodiment of the present invention a foreign person from Finland receiving income from an investment in U.S.-based oil, gas and other natural resource Potential Producing Properties that utilizes the inventor's financial structure and investment vehicle (as illustrated in FIG. 2) will be subject to the Finland/U.S. withholding tax on the “Interest on real property mortgages”.

According to one embodiment of the present invention a foreign person from Finland receiving income from an investment in U.S.-based oil, gas and other natural resource Producing Properties that utilizes the inventor's financial structure and investment vehicle (as illustrated in FIG. 1) will be subject to the Finland/U.S. withholding tax on the “Interest on real property mortgages”.

According to one embodiment of the present invention a foreign person from France receiving income from an investment in U.S.-based oil, gas and other natural resource Potential Producing Properties that utilizes the inventor's financial structure and investment vehicle (as illustrated in FIG. 2) will be subject to the France/U.S. withholding tax on the “Interest on real property mortgages”.

According to one embodiment of the present invention a foreign person from France receiving income from an investment in U.S.-based oil, gas and other natural resource Producing Properties that utilizes the inventor's financial structure and investment vehicle (as illustrated in FIG. 1) will be subject to the France/U.S. withholding tax on the “Interest on real property mortgages”.

According to one embodiment of the present invention a foreign person from Germany receiving income from an investment in U.S.-based oil, gas and other natural resource Potential Producing Properties that utilizes the inventor's financial structure and investment vehicle (as illustrated in FIG. 2) will be subject to the Germany/U.S. withholding tax on the “Interest on real property mortgages”.

According to one embodiment of the present invention a foreign person from Germany receiving income from an investment in U.S.-based oil, gas and other natural resource Producing Properties that utilizes the inventor's financial structure and investment vehicle (as illustrated in FIG. 1) will be subject to the Germany/U.S. withholding tax on the “Interest on real property mortgages”.

According to one embodiment of the present invention a foreign person from Greece receiving income from an investment in U.S.-based oil, gas and other natural resource Potential Producing Properties that utilizes the inventor's financial structure and investment vehicle (as illustrated in FIG. 2) will be subject to the Greece/U.S. withholding tax on the “Interest on real property mortgages”.

According to one embodiment of the present invention a foreign person from Greece receiving income from an investment in U.S.-based oil, gas and other natural resource Producing Properties that utilizes the inventor's financial structure and investment vehicle (as illustrated in FIG. 1) will be subject to the Greece/U.S. withholding tax on the “Interest on real property mortgages”.

According to one embodiment of the present invention a foreign person from Hungary receiving income from an investment in U.S.-based oil, gas and other natural resource Producing Properties that utilizes the inventor's financial structure and investment vehicle (as illustrated in FIG. 1) will be subject to the Hungary/U.S. withholding tax on the “Interest on real property mortgages”.

According to one embodiment of the present invention a foreign person from Hungary receiving income from an investment in U.S.-based oil, gas and other natural resource Potential Producing Properties that utilizes the inventor's financial structure and investment vehicle (as illustrated in FIG. 2) will be subject to the Hungary/U.S. withholding tax on the “Interest on real property mortgages”.

According to one embodiment of the present invention a foreign person from Iceland receiving income from an investment in U.S.-based oil, gas and other natural resource Producing Properties that utilizes the inventor's financial structure and investment vehicle (as illustrated in FIG. 1) will be subject to the Iceland/U.S. withholding tax on the “Interest on real property mortgages”.

According to one embodiment of the present invention a foreign person Iceland receiving income from an investment in U.S.-based oil, gas and other natural resource Potential Producing Properties that utilizes the inventor's financial structure and investment vehicle (as illustrated in FIG. 2) will be subject to the Iceland/U.S. withholding tax on the “Interest on real property mortgages”.

According to one embodiment of the present invention a foreign person from India receiving income from an investment in U.S.-based oil, gas and other natural resource Producing Properties that utilizes the inventor's financial structure and investment vehicle (as illustrated in FIG. 1) will be subject to the India/U.S. withholding tax on the “Interest on real property mortgages”.

According to one embodiment of the present invention a foreign person from India receiving income from an investment in U.S.-based oil, gas and other natural resource Potential Producing Properties that utilizes the inventor's financial structure and investment vehicle (as illustrated in FIG. 2) will be subject to the India/U.S. withholding tax on the “Interest on real property mortgages”.

According to one embodiment of the present invention a foreign person from Indonesia receiving income from an investment in U.S.-based oil, gas and other natural resource Producing Properties that utilizes the inventor's financial structure and investment vehicle (as illustrated in FIG. 1) will be subject to the Indonesia/U.S. withholding tax on the “Interest on real property mortgages”.

According to one embodiment of the present invention a foreign person from Indonesia receiving income from an investment in U.S.-based oil, gas and other natural resource Potential Producing Properties that utilizes the inventor's financial structure and investment vehicle (as illustrated in FIG. 2) will be subject to the Indonesia/U.S. withholding tax on the “Interest on real property mortgages”.

According to one embodiment of the present invention a foreign person from Ireland receiving income from an investment in U.S.-based oil, gas and other natural resource Producing Properties that utilizes the inventor's financial structure and investment vehicle (as illustrated in FIG. 1) will be subject to the Ireland/U.S. withholding tax on the “Interest on real property mortgages”.

According to one embodiment of the present invention a foreign person from Ireland receiving income from an investment in U.S.-based oil, gas and other natural resource Potential Producing Properties that utilizes the inventor's financial structure and investment vehicle (as illustrated in FIG. 2) will be subject to the Ireland/U.S. withholding tax on the “Interest on real property mortgages”.

According to one embodiment of the present invention a foreign person from Israel receiving income from an investment in U.S.-based oil, gas and other natural resource Producing Properties that utilizes the inventor's financial structure and investment vehicle (as illustrated in FIG. 1) will be subject to the Isreal/U.S. withholding tax on the “Interest on real property mortgages”.

According to one embodiment of the present invention a foreign person from Israel receiving income from an investment in U.S.-based oil, gas and other natural resource Potential Producing Properties that utilizes the inventor's financial structure and investment vehicle (as illustrated in FIG. 2) will be subject to the Israel/U.S. withholding tax on the “Interest on real property mortgages”.

According to one embodiment of the present invention a foreign person from Italy receiving income from an investment in U.S.-based oil, gas and other natural resource Producing Properties that utilizes the inventor's financial structure and investment vehicle (as illustrated in FIG. 1) will be subject to the Italy/U.S. withholding tax on the “Interest on real property mortgages”.

According to one embodiment of the present invention a foreign person from Italy receiving income from an investment in U.S.-based oil, gas and other natural resource Potential Producing Properties that utilizes the inventor's financial structure and investment vehicle (as illustrated in FIG. 2) will be subject to the Italy/U.S. withholding tax on the “Interest on real property mortgages”.

According to one embodiment of the present invention a foreign person from Jamaica receiving income from an investment in U.S.-based oil, gas and other natural resource Producing Properties that utilizes the inventor's financial structure and investment vehicle (as illustrated in FIG. 1) will be subject to the Jamaica/U.S. withholding tax on the “Interest on real property mortgages”.

According to one embodiment of the present invention a foreign person from Jamaica receiving income from an investment in U.S.-based oil, gas and other natural resource Potential Producing Properties that utilizes the inventor's financial structure and investment vehicle (as illustrated in FIG. 2) will be subject to the Jamaica/U.S. withholding tax on the “Interest on real property mortgages”.

According to one embodiment of the present invention a foreign person from Japan receiving income from an investment in U.S.-based oil, gas and other natural resource Producing Properties that utilizes the inventor's financial structure and investment vehicle (as illustrated in FIG. 1) will be subject to the Japan/U.S. withholding tax on the “Interest on real property mortgages”.

According to one embodiment of the present invention a foreign person from Japan receiving income from an investment in U.S.-based oil, gas and other natural resource Potential Producing Properties that utilizes the inventor's financial structure and investment vehicle (as illustrated in FIG. 2) will be subject to the Japan/U.S. withholding tax on the “Interest on real property mortgages”.

According to one embodiment of the present invention a foreign person from Kazakstan receiving income from an investment in U.S.-based oil, gas and other natural resource Producing Properties that utilizes the inventor's financial structure and investment vehicle (as illustrated in FIG. 1) will be subject to the Kazaksta/U.S. withholding tax on the “Interest on real property mortgages”.

According to one embodiment of the present invention a foreign person from Kazakstan receiving income from an investment in U.S.-based oil, gas and other natural resource Potential Producing Properties that utilizes the inventor's financial structure and investment vehicle (as illustrated in FIG. 2) will be subject to the Kazakstan/U.S. withholding tax on the “Interest on real property mortgages”.

According to one embodiment of the present invention a foreign person from Republic of Korea receiving income from an investment in U.S.-based oil, gas and other natural resource Producing Properties that utilizes the inventor's financial structure and investment vehicle (as illustrated in FIG. 1) will be subject to the Republic of Korea/U.S. withholding tax on the “Interest on real property mortgages”.

According to one embodiment of the present invention a foreign person from Republic of Korea receiving income from an investment in U.S.-based oil, gas and other natural resource Potential Producing Properties that utilizes the inventor's financial structure and investment vehicle (as illustrated in FIG. 2) will be subject to the Republic of Korea/U.S. withholding tax on the “Interest on real property mortgages”.

According to one embodiment of the present invention a foreign person from Latvia receiving income from an investment in U.S.-based oil, gas and other natural resource Producing Properties that utilizes the inventor's financial structure and investment vehicle (as illustrated in FIG. 1) will be subject to the Latvia/U.S. withholding tax on the “Interest on real property mortgages”.

According to one embodiment of the present invention a foreign person from Latvia receiving income from an investment in U.S.-based oil, gas and other natural resource Potential Producing Properties that utilizes the inventor's financial structure and investment vehicle (as illustrated in FIG. 2) will be subject to the Latvia/U.S. withholding tax on the “Interest on real property mortgages”.

According to one embodiment of the present invention a foreign person from Lithuania receiving income from an investment in U.S.-based oil, gas and other natural resource Producing Properties that utilizes the inventor's financial structure and investment vehicle (as illustrated in FIG. 1) will be subject to the Lithuania/U.S. withholding tax on the “Interest on real property mortgages”.

According to one embodiment of the present invention a foreign person from Lithuania receiving income from an investment in U.S.-based oil, gas and other natural resource Potential Producing Properties that utilizes the inventor's financial structure and investment vehicle (as illustrated in FIG. 2) will be subject to the Lithuania/U.S. withholding tax on the “Interest on real property mortgages”.

According to one embodiment of the present invention a foreign person from Luxembourg receiving income from an investment in U.S.-based oil, gas and other natural resource Producing Properties that utilizes the inventor's financial structure and investment vehicle (as illustrated in FIG. 1) will be subject to the Luxembourg/U.S. withholding tax on the “Interest on real property mortgages”.

According to one embodiment of the present invention a foreign person from Luxembourg receiving income from an investment in U.S.-based oil, gas and other natural resource Potential Producing Properties that utilizes the inventor's financial structure and investment vehicle (as illustrated in FIG. 2) will be subject to the Luxembourg/U.S. withholding tax on the “Interest on real property mortgages”.

According to one embodiment of the present invention a foreign person from Mexico receiving income from an investment in U.S.-based oil, gas and other natural resource Producing Properties that utilizes the inventor's financial structure and investment vehicle (as illustrated in FIG. 1) will be subject to the Mexico/U.S. withholding tax on the “Interest on real property mortgages”.

According to one embodiment of the present invention a foreign person from Mexico receiving income from an investment in U.S.-based oil, gas and other natural resource Potential Producing Properties that utilizes the inventor's financial structure and investment vehicle (as illustrated in FIG. 2) will be subject to the Mexico/U.S. withholding tax on the “Interest on real property mortgages”.

According to one embodiment of the present invention a foreign person from Morocco receiving income from an investment in U.S.-based oil, gas and other natural resource Producing Properties that utilizes the inventor's financial structure and investment vehicle (as illustrated in FIG. 1) will be subject to the Morocco/U.S. withholding tax on the “Interest on real property mortgages”.

According to one embodiment of the present invention a foreign person from Morocco receiving income from an investment in U.S.-based oil, gas and other natural resource Potential Producing Properties that utilizes the inventor's financial structure and investment vehicle (as illustrated in FIG. 2) will be subject to the Morocco/U.S. withholding tax on the “Interest on real property mortgages”.

According to one embodiment of the present invention a foreign person from Netherlands receiving income from an investment in U.S.-based oil, gas and other natural resource Producing Properties that utilizes the inventor's financial structure and investment vehicle (as illustrated in FIG. 1) will be subject to the Netherlands/U.S. withholding tax on the “Interest on real property mortgages”.

According to one embodiment of the present invention a foreign person from Netherlands receiving income from an investment in U.S.-based oil, gas and other natural resource Potential Producing Properties that utilizes the inventor's financial structure and investment vehicle (as illustrated in FIG. 2) will be subject to the Netherlands/U.S. withholding tax on the “Interest on real property mortgages”.

According to one embodiment of the present invention a foreign person from New Zealand receiving income from an investment in U.S.-based oil, gas and other natural resource Producing Properties that utilizes the inventor's financial structure and investment vehicle (as illustrated in FIG. 1) will be subject to the New Zealand/U.S. withholding tax on the “Interest on real property mortgages”.

According to one embodiment of the present invention a foreign person from New Zealand receiving income from an investment in U.S.-based oil, gas and other natural resource Potential Producing Properties that utilizes the inventor's financial structure and investment vehicle (as illustrated in FIG. 2) will be subject to the New Zealand/U.S. withholding tax on the “Interest on real property mortgages”.

According to one embodiment of the present invention a foreign person from Norway receiving income from an investment in U.S.-based oil, gas and other natural resource Producing Properties that utilizes the inventor's financial structure and investment vehicle (as illustrated in FIG. 1) will be subject to the Norway/U.S. withholding tax on the “Interest on real property mortgages”.

According to one embodiment of the present invention a foreign person from Norway receiving income from an investment in U.S.-based oil, gas and other natural resource Potential Producing Properties that utilizes the inventor's financial structure and investment vehicle (as illustrated in FIG. 2) will be subject to the Norway/U.S. withholding tax on the “Interest on real property mortgages”.

According to one embodiment of the present invention a foreign person from Pakistan receiving income from an investment in U.S.-based oil, gas and other natural resource Producing Properties that utilizes the inventor's financial structure and investment vehicle (as illustrated in FIG. 1) will be subject to the Pakistan/U.S. withholding tax on the “Interest on real property mortgages”.

According to one embodiment of the present invention a foreign person from Pakistan receiving income from an investment in U.S.-based oil, gas and other natural resource Potential Producing Properties that utilizes the inventor's financial structure and investment vehicle (as illustrated in FIG. 2) will be subject to the Pakistan/U.S. withholding tax on the “Interest on real property mortgages”.

According to one embodiment of the present invention a foreign person from Philippines receiving income from an investment in U.S.-based oil, gas and other natural resource Producing Properties that utilizes the inventor's financial structure and investment vehicle (as illustrated in FIG. 1) will be subject to the Philippines/U.S. withholding tax on the “Interest on real property mortgages”.

According to one embodiment of the present invention a foreign person from Philippines receiving income from an investment in U.S.-based oil, gas and other natural resource Potential Producing Properties that utilizes the inventor's financial structure and investment vehicle (as illustrated in FIG. 2) will be subject to the Philippines/U.S. withholding tax on the “Interest on real property mortgages”.

According to one embodiment of the present invention a foreign person from Poland receiving income from an investment in U.S.-based oil, gas and other natural resource Producing Properties that utilizes the inventor's financial structure and investment vehicle (as illustrated in FIG. 1) will be subject to the Poland/U.S. withholding tax on the “Interest on real property mortgages”.

According to one embodiment of the present invention a foreign person from Poland receiving income from an investment in U.S.-based oil, gas and other natural resource Potential Producing Properties that utilizes the inventor's financial structure and investment vehicle (as illustrated in FIG. 2) will be subject to the Poland/U.S. withholding tax on the “Interest on real property mortgages”.

According to one embodiment of the present invention a foreign person from Portugal receiving income from an investment in U.S.-based oil, gas and other natural resource Producing Properties that utilizes the inventor's financial structure and investment vehicle (as illustrated in FIG. 1) will be subject to the Portugal/U.S. withholding tax on the “Interest on real property mortgages”.

According to one embodiment of the present invention a foreign person from Portugal receiving income from an investment in U.S.-based oil, gas and other natural resource Potential Producing Properties that utilizes the inventor's financial structure and investment vehicle (as illustrated in FIG. 2) will be subject to the Portugal/U.S. withholding tax on the “Interest on real property mortgages”.

According to one embodiment of the present invention a foreign person from Romania receiving income from an investment in U.S.-based oil, gas and other natural resource Producing Properties that utilizes the inventor's financial structure and investment vehicle (as illustrated in FIG. 1) will be subject to the Romania/U.S. withholding tax on the “Interest on real property mortgages”.

According to one embodiment of the present invention a foreign person from Romania receiving income from an investment in U.S.-based oil, gas and other natural resource Potential Producing Properties that utilizes the inventor's financial structure and investment vehicle (as illustrated in FIG. 2) will be subject to the Romania/U.S. withholding tax on the “Interest on real property mortgages”.

According to one embodiment of the present invention a foreign person from Russia receiving income from an investment in U.S.-based oil, gas and other natural resource Producing Properties that utilizes the inventor's financial structure and investment vehicle (as illustrated in FIG. 1) will be subject to the Russia/U.S. withholding tax on the “Interest on real property mortgages”.

According to one embodiment of the present invention a foreign person from Russia receiving income from an investment in U.S.-based oil, gas and other natural resource Potential Producing Properties that utilizes the inventor's financial structure and investment vehicle (as illustrated in FIG. 2) will be subject to the Russia/U.S. withholding tax on the “Interest on real property mortgages”.

According to one embodiment of the present invention a foreign person from Slovak Republic receiving income from an investment in U.S.-based oil, gas and other natural resource Producing Properties that utilizes the inventor's financial structure and investment vehicle (as illustrated in FIG. 1) will be subject to the Slovak Republic/U.S. withholding tax on the “Interest on real property mortgages”.

According to one embodiment of the present invention a foreign person from Slovak Republic receiving income from an investment in U.S.-based oil, gas and other natural resource Potential Producing Properties that utilizes the inventor's financial structure and investment vehicle (as illustrated in FIG. 2) will be subject to the Slovak Republic/U.S. withholding tax on the “Interest on real property mortgages”.

According to one embodiment of the present invention a foreign person from Slovenia receiving income from an investment in U.S.-based oil, gas and other natural resource Producing Properties that utilizes the inventor's financial structure and investment vehicle (as illustrated in FIG. 1) will be subject to the Slovenia/U.S. withholding tax on the “Interest on real property mortgages”.

According to one embodiment of the present invention a foreign person from Slovenia receiving income from an investment in U.S.-based oil, gas and other natural resource Potential Producing Properties that utilizes the inventor's financial structure and investment vehicle (as illustrated in FIG. 2) will be subject to the Slovenia/U.S. withholding tax on the “Interest on real property mortgages”.

According to one embodiment of the present invention a foreign person from South Africa receiving income from an investment in U.S.-based oil, gas and other natural resource Producing Properties that utilizes the inventor's financial structure and investment vehicle (as illustrated in FIG. 1) will be subject to the South Africa/U.S. withholding tax on the “Interest on real property mortgages”.

According to one embodiment of the present invention a foreign person from South Africa receiving income from an investment in U.S.-based oil, gas and other natural resource Potential Producing Properties that utilizes the inventor's financial structure and investment vehicle (as illustrated in FIG. 2) will be subject to the South Africa/U.S. withholding tax on the “Interest on real property mortgages”.

According to one embodiment of the present invention a foreign person from Spain receiving income from an investment in U.S.-based oil, gas and other natural resource Producing Properties that utilizes the inventor's financial structure and investment vehicle (as illustrated in FIG. 1) will be subject to the Spain/U.S. withholding tax on the “Interest on real property mortgages”.

According to one embodiment of the present invention a foreign person from Spain receiving income from an investment in U.S.-based oil, gas and other natural resource Potential Producing Properties that utilizes the inventor's financial structure and investment vehicle (as illustrated in FIG. 2) will be subject to the Spain/U.S. withholding tax on the “Interest on real property mortgages”.

According to one embodiment of the present invention a foreign person from Sweden receiving income from an investment in U.S.-based oil, gas and other natural resource Producing Properties that utilizes the inventor's financial structure and investment vehicle (as illustrated in FIG. 1) will be subject to the Sweden/U.S. withholding tax on the “Interest on real property mortgages”.

According to one embodiment of the present invention a foreign person from Sweden receiving income from an investment in U.S.-based oil, gas and other natural resource Potential Producing Properties that utilizes the inventor's financial structure and investment vehicle (as illustrated in FIG. 2) will be subject to the Sweden/U.S. withholding tax on the “Interest on real property mortgages”.

According to one embodiment of the present invention a foreign person from Switzerland receiving income from an investment in U.S.-based oil, gas and other natural resource Producing Properties that utilizes the inventor's financial structure and investment vehicle (as illustrated in FIG. 1) will be subject to the Switzerland/U.S. withholding tax on the “Interest on real property mortgages”.

According to one embodiment of the present invention a foreign person from Switzerland receiving income from an investment in U.S.-based oil, gas and other natural resource Potential Producing Properties that utilizes the inventor's financial structure and investment vehicle (as illustrated in FIG. 2) will be subject to the Switzerland/U.S. withholding tax on the “Interest on real property mortgages”.

According to one embodiment of the present invention a foreign person from Thailand receiving income from an investment in U.S.-based oil, gas and other natural resource Producing Properties that utilizes the inventor's financial structure and investment vehicle (as illustrated in FIG. 1) will be subject to the Thailand/U.S. withholding tax on the “Interest on real property mortgages”.

According to one embodiment of the present invention a foreign person from Thailand receiving income from an investment in U.S.-based oil, gas and other natural resource Potential Producing Properties that utilizes the inventor's financial structure and investment vehicle (as illustrated in FIG. 2) will be subject to the Thailand/U.S. withholding tax on the “Interest on real property mortgages”.

According to one embodiment of the present invention a foreign person from Trinidad & Tobago receiving income from an investment in U.S.-based oil, gas and other natural resource Producing Properties that utilizes the inventor's financial structure and investment vehicle (as illustrated in FIG. 1) will be subject to the Trinidad & Tobago/U.S. withholding tax on the “Interest on real property mortgages”.

According to one embodiment of the present invention a foreign person from Trinidad & Tobago receiving income from an investment in U.S.-based oil, gas and other natural resource Potential Producing Properties that utilizes the inventor's financial structure and investment vehicle (as illustrated in FIG. 2) will be subject to the Trinidad & Tobago/U.S. withholding tax on the “Interest on real property mortgages”.

According to one embodiment of the present invention a foreign person from Tunisia receiving income from an investment in U.S.-based oil, gas and other natural resource Producing Properties that utilizes the inventor's financial structure and investment vehicle (as illustrated in FIG. 1) will be subject to the Tunisial U.S. withholding tax on the “Interest on real property mortgages”.

According to one embodiment of the present invention a foreign person from Tunisia receiving income from an investment in U.S.-based oil, gas and other natural resource Potential Producing Properties that utilizes the inventor's financial structure and investment vehicle (as illustrated in FIG. 2) will be subject to the Tunisia/U.S. withholding tax on the “Interest on real property mortgages”.

According to one embodiment of the present invention a foreign person from Turkey receiving income from an investment in U.S.-based oil, gas and other natural resource Producing Properties that utilizes the inventor's financial structure and investment vehicle (as illustrated in FIG. 1) will be subject to the Turkey/U.S. withholding tax on the “Interest on real property mortgages”.

According to one embodiment of the present invention a foreign person from Turkey receiving income from an investment in U.S.-based oil, gas and other natural resource Potential Producing Properties that utilizes the inventor's financial structure and investment vehicle (as illustrated in FIG. 2) will be subject to the Turkey/U.S. withholding tax on the “Interest on real property mortgages”.

According to one embodiment of the present invention a foreign person from Ukraine receiving income from an investment in U.S.-based oil, gas and other natural resource Producing Properties that utilizes the inventor's financial structure and investment vehicle (as illustrated in FIG. 1) will be subject to the Ukraine/U.S. withholding tax on the “Interest on real property mortgages”.

According to one embodiment of the present invention a foreign person from Ukraine receiving income from an investment in U.S.-based oil, gas and other natural resource Potential Producing Properties that utilizes the inventor's financial structure and investment vehicle (as illustrated in FIG. 2) will be subject to the Ukraine/U.S. withholding tax on the “Interest on real property mortgages”.

According to one embodiment of the present invention a foreign person from United Kingdom receiving income from an investment in U.S.-based oil, gas and other natural resource Producing Properties that utilizes the inventor's financial structure and investment vehicle (as illustrated in FIG. 1) will be subject to the United Kingdom/U.S. withholding tax on the “Interest on real property mortgages”.

According to one embodiment of the present invention a foreign person from United Kingdom receiving income from an investment in U.S.-based oil, gas and other natural resource Potential Producing Properties that utilizes the inventor's financial structure and investment vehicle (as illustrated in FIG. 2) will be subject to the United Kingdom/U.S. withholding tax on the “Interest on real property mortgages”.

According to one embodiment of the present invention a foreign person from Venezuela receiving income from an investment in U.S.-based oil, gas and other natural resource Producing Properties that utilizes the inventor's financial structure and investment vehicle (as illustrated in FIG. 1) will be subject to the Venezuela/U.S. withholding tax on the “Interest on real property mortgages”.

According to one embodiment of the present invention a foreign person from Venezuela receiving income from an investment in U.S.-based oil, gas and other natural resource Potential Producing Properties that utilizes the inventor's financial structure and investment vehicle (as illustrated in FIG. 2) will be subject to the Venezuela/U.S. withholding tax on the “Interest on real property mortgages”.

According to one embodiment of the present invention a foreign person from Other Countries receiving income from an investment in U.S.-based oil, gas and other natural resource Producing Properties that utilizes the inventor's financial structure and investment vehicle (as illustrated in FIG. 1) will be subject to the Other Countries/U.S. withholding tax on the “Interest on real property mortgages”.

According to one embodiment of the present invention a foreign person from Other Countries receiving income from an investment in U.S.-based oil, gas and other natural resource Potential Producing Properties that utilizes the inventor's financial structure and investment vehicle (as illustrated in FIG. 2) will be subject to the Other Countries/U.S. withholding tax on the “Interest on real property mortgages”.

According to one embodiment of the present invention a U.S. investor (individual, corporation, partnership, trust, etc.) receiving income from an investment in U.S.-based oil, gas and other natural resource Producing Properties that utilizes the inventor's financial structure and investment vehicle will be subject to the U.S. tax on the interest on real property mortgages.

According to one embodiment of the present invention a U.S. investor (individual, corporation, partnership, trust, etc.) receiving income from an investment in U.S.-based oil, gas and other natural resource Potential producing Properties that utilizes the inventor's financial structure and investment vehicle will be subject to the U.S. tax on interest on real property mortgages.

According to one embodiment of the present invention a U.S. investor (individual, corporation, partnership, trust, etc.) receiving income from an investment in Canadian oil, gas and other natural resource Producing Properties that utilizes the inventor's financial structure and investment vehicle will be subject to the Canada/U.S. treaty withholding tax on “Interest on real property mortgages”.

According to one embodiment of the present invention a U.S. investor (individual, corporation, partnership, trust, etc.) receiving income from an investment in Canadian oil, gas and other natural resource Potential Producing Properties that utilizes the inventor's financial structure and investment vehicle will be subject to the Canada/U.S. withholding tax on “Interest on real property mortgages”.

According to one embodiment of the present invention a foreign person receiving income from an investment in Canadian oil, gas and other natural resource Producing Properties that utilizes the inventor's financial structure and investment vehicle will be subject to the Canada/Foreign Person's resident country treaty withholding tax on interest on real property mortgages.

According to one embodiment of the present invention a foreign person receiving income from an investment in Canadian oil, gas and other natural resource Potential Producing Properties that utilizes the inventor's financial structure and investment vehicle will be subject to the Canada/Foreign Person's resident country treaty withholding tax on interest on real property mortgages.

According to one embodiment of the present invention a foreign person from China receiving income from an investment in Canadian oil, gas and other natural resource Producing Properties that utilizes the inventor's financial structure and investment vehicle will be subject to the Canada/China treaty withholding tax on interest on real property mortgages.

According to one embodiment of the present invention a foreign person from China receiving income from an investment in Canadian oil, gas and other natural resource Potential producing Properties that utilizes the inventor's financial structure and investment vehicle will be subject to the Canada/China treaty withholding tax on interest on real property mortgages.

According to one embodiment of the present invention a foreign person from India receiving income from an investment in Canadian oil, gas and other natural resource Producing Properties that utilizes the inventor's financial structure and investment vehicle will be subject to the Canada/India treaty withholding tax on interest on real property mortgages.

According to one embodiment of the present invention a foreign person from India receiving income from an investment in Canadian oil, gas and other natural resource Potential Producing Properties that utilizes the inventor's financial structure and investment vehicle will be subject to the Canada/India treaty withholding tax on interest on real property mortgages.

According to one embodiment of the present invention a foreign person from Luxembourg receiving income from an investment in Canadian oil, gas and other natural resource Producing Properties that utilizes the inventor's financial structure and investment vehicle will be subject to the Canada/Luxembourg treaty withholding tax on interest on real property mortgages.

According to one embodiment of the present invention a foreign person from Luxembourg receiving income from an investment in Canadian oil, gas and other natural resource Potential Producing Properties that utilizes the inventor's financial structure and investment vehicle will be subject to the Canada/Luxembourg treaty withholding tax on interest on real property mortgages.

What is claimed is:

1. A method for providing a financial structure and investment vehicle that utilizes Section 636 of the United States (U.S.) tax code and enables the income received from a foreign person's investment in United States (U.S.) based oil, gas and other natural resource producing properties to be treated as production payments, thus enabling the payments to be considered as payments of interest and principal on a mortgage loan; as a result, the foreign person(s) making the investment is subject to the United States (U.S.) withholding tax that specifically pertains to its resident country's negotiated treaty rate with the United States (U.S.) on interest on real property mortgages. The method comprising the steps of:
said foreign person(s) makes an investment in the form of a loan to a United States (U.S.) entity that is not owned by said foreign person(s) and that takes on one of the forms like Limited Liability Company (LLC), Limited Liability Partnership (LLP) or Limited Partnership (LP);
in consideration of the loan, said United States (U.S.) entity pays foreign person(s) interest that does not to exceed the lawful rate set by the State jurisdiction of the United States (U.S.) entity and a principal payment, the timing of which is determined by the pre-negotiated terms of the investment;
said United States (U.S.) entity uses the loan to acquire the rights to the production derived from the producing property from a separate United States (U.S.) entity that is not owned by foreign person(s), that takes on one of the forms like Limited Liability Company (LLC), Limited Liability Partnership (LLP) or Limited Partnership (LP)), wherein said entity owns title to said producing properties;
said second United States (U.S.) entity provides said first United States (U.S.) entity with a payment resulting from the production of the underlying assets owned by said second entity, wherein said payment is recategorized as a production payment that is taxed as interest on a mortgage loan, wherein said payment can be adjusted according to a pre-determined formula to reflect either an appreciation or depreciation in the value of the said producing properties, or for management fees as negotiated between said entities; and
said first United States (U.S.) entity then provides foreign person(s) with a payment that is also recategorized as said production payment, wherein said production payment is taxed as interest on a mortgage loan.

2. The method of claim 1, wherein said financial structure and investment vehicle has an option of hedging out of said foreign person's exposure to the United States (U.S.) dollar, either fully or partially, using derivatives.

3. The method of claim 2, wherein said option of hedging out can be executed separately on behalf of each said foreign person depending on its specific need.

4. The method of claim 2, wherein said option of hedging out can be executed jointly on behalf of one or more foreign persons depending upon their specific investment objectives.

5. The method of claim 1, wherein said financial structure and investment vehicle has an option of hedging out of said foreign person's exposure to fluctuations in the price of said underlying natural resource commodity, either fully or partially, using derivatives.

6. The method of claim 5, wherein said option of hedging out can be executed separately on behalf of each said foreign person depending on its specific need.

7. The method of claim 5, wherein said option of hedging out can be executed jointly on behalf of one or more said foreign persons depending upon their specific investment objectives.

8. A method for providing a financial structure and investment vehicle that utilizes Section 636 of the United States (U.S.) code and enables the income received from a foreign person's investment in United States (U.S.) based oil, gas and other natural resource potential producing properties to be recategorized as production payments, thus enabling them to be categorized as payments of interest and principal on a mortgage loan; as a result, said foreign person making the investment is subject to the United States (U.S.) withholding tax that specifically pertains to its resident country's negotiated treaty rate with the United States (U.S.) on interest on real property mortgages. The method comprising the steps of:
said foreign person(s) makes an investment in the form of a loan to a United States (U.S.) entity that is not owned by said foreign person(s) and that takes on one of the forms like Limited Liability Company (LLC), Limited Liability Partnership (LLP) or Limited Partnership (LP);
in consideration of the loan, said United States (U.S.) entity pays said foreign person(s) interest that does not to exceed the lawful rate set by the State jurisdiction of the United States (U.S.) entity and a principal payment, the timing of which is determined by the pre-negotiated terms of the investment;
a new United States (U.S.) entity is formed to perform the exploration and development that is not owned by said foreign person (s) and that takes on one of the forms like Limited Liability Company (LLC), Limited Liability Partnership (LLP) or Limited Partnership (LP), wherein said entity owns title to said potential producing properties that are to be explored and developed;
said first United States (U.S.) entity makes an investment into said second United States (U.S.) entity in the form of a loan and an option to purchase said production payment at a pre-determined price; and
in consideration of the loan, said second United States (U.S.) entity pays said first United States (U.S.) entity interest that does not to exceed the lawful rate set by the State jurisdiction of the United States (U.S.) entity, a principal payment that is determined by the negotiated term of the investment and a production payment resulting from the exploration and development of the underlying assets owned by said second entity if the option is exercised.

9. The method of claim 8, wherein said production payment is taxed as interest on a mortgage loan.

10. The method of claim 8, wherein said payment can be adjusted according to a predetermined formula to reflect either an appreciation or depreciation in the value of said underlying assets or for management fees as negotiated between said entities.

11. The method of claim 8, wherein said first United States (U.S.) entity provides said foreign person with a payment that is recategorized as a production payment and is taxed as interest on a mortgage loan, if said option is exercised.

12. The method of claim 8, wherein said financial structure and investment vehicle has the option of hedging out of said foreign person's exposure to the United States (U.S.) dollar, either fully or partially, using derivatives.

13. The method of claim 12, wherein said option of hedging out can be executed separately on behalf of each said foreign person depending on its specific need.

14. The method of claim 12, wherein said option of hedging out can be executed jointly on behalf of one or more said foreign persons depending upon their specific investment objectives.

15. The method of claim 8, wherein said financial structure and investment vehicle has an option of hedging out of said foreign person's exposure to fluctuations in the price of said underlying natural resource commodity, either fully or partially, using derivatives.

16. The method of claim 15, wherein said option of hedging out can be executed separately on behalf of each said foreign person depending on its specific need.

17. The method of claim 15, wherein said option of hedging out can be executed jointly on behalf of one or more said foreign persons depending upon their specific investment objectives.
